(19) United States
(12) Patent Application Publication
(10) Pub. No.: US 2019/0092237 A1
(43) Pub. Date: Mar. 28, 2019

(54) CAMERA-DISPLAY SYSTEM FOR A VEHICLE

(71) Applicant: Continental Automotive Systems, Inc., Auburn Hills, MI (US)

(72) Inventors: Ibro Muharemovic, Warren, MI (US); Brandon Herzog, Waterford, MI (US); Hao Sun, Auburn Hills, MI (US)

(73) Assignee: Continental Automotive Systems, Inc., Auburn Hills, MI (US)

(21) Appl. No.: 16/141,640

(22) Filed: Sep. 25, 2018

Related U.S. Application Data
(60) Provisional application No. 62/563,272, filed on Sep. 26, 2017.

(51) Int. Cl. B60R 1/00

(52) U.S. Cl. CPC B60R 1/00; H04N 5/247

(57) ABSTRACT

A vehicle includes a camera disposed on a side of the vehicle and configured to capture images associated with a field-of-view adjacent the side of the vehicle. A display is disposed adjacent or near the side of the vehicle and in communication with the camera to display the images captured by the camera. The display may supplement and/or replace traditional side-view mirrors of the vehicle.

### CROSS REFERENCE TO RELATED APPLICATION

This application claims the benefit of provisional patent application No. 62/563,272, filed Sep. 25, 2017, which is hereby incorporated by reference.

### TECHNICAL FIELD

The technical field relates generally to displays on a dashboard of a vehicle and more particularly to displays which display images instead of mirrors.

### BACKGROUND

Motor vehicles have long included side-view mirrors in an attempt to allow a driver to see objects on either side, and behind, the vehicle. Of course, these

### SUMMARY

In one exemplary embodiment, a camera-display system for a vehicle having two sides is presented. The system includes a camera configured to capture images associated with a field-of-view adjacent one side of the vehicle. The system also includes a display disposed adjacent the side of the vehicle and in communication with the camera to display the images captured by the camera.

In one exemplary embodiment, a vehicle includes two sides. The vehicle includes a camera configured to capture images associated with a field-of-view adjacent one side. The vehicle also includes a display disposed adjacent the side of the vehicle and in communication with the camera to display the images captured by the camera.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a top-view block diagram of a vehicle according to one exemplary embodiment; and

FIG. 2 is a front-view block diagram of a dashboard of the vehicle according to one exemplary embodiment.

### DETAILED DESCRIPTION

Referring to the Figures, wherein like numerals indicate like parts throughout the several views, a vehicle 100 with a camera-display system 101 is shown and described herein.

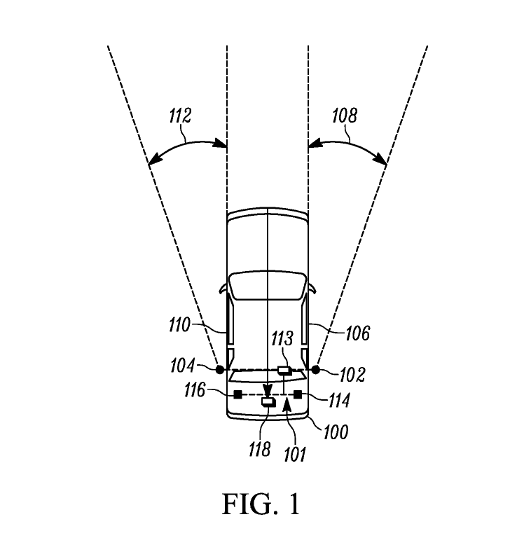

Referring to FIG. 1, the system 101 includes at least one camera 102, 104 for capturing images of the environment around the vehicle 100. In the embodiment shown in FIG. 1, a first camera 102 is disposed on a first side 106 of the vehicle 100 to capture images in a first field of view 108 while a second camera 104 is disposed on a second side 110 of the vehicle to capture images in a second field of view 112. The cameras 102, 104 may be disposed as part of a side-view mirror housing (not shown) or in place of a side-view mirror (not shown). Of course, other suitable locations for the cameras 102, 104 may also be realized.

The system 101 may also include a processor 113. The processor 113 is in communication with the at least one camera 102, 104 to receive signals from the at least one camera 102, 104 that include the images. The processor 113 performs processing (or conditioning) of the signals and then provides the conditioned signals to a display 114, 116 as described below. The processor 113 may be a microprocessor, microcontroller, digital signal processor, application specific integrated circuit, and/or other suitable device capable of processing images.

The system 101 further includes at least one display 114, 116. In the exemplary embodiment shown in FIG. 1, the system 101 includes a first display 114 and a second display 116. The first display 114 is in communication with the first camera 102 and is configured to display images from the first field of view 108. Similarly, the second display 116 is in communication with the second camera 104 and configured to display images from the second field of view 112. The processor 113 may be in communication with the cameras 102, 104 and the displays 114, 116 to provide appropriate signal processing.

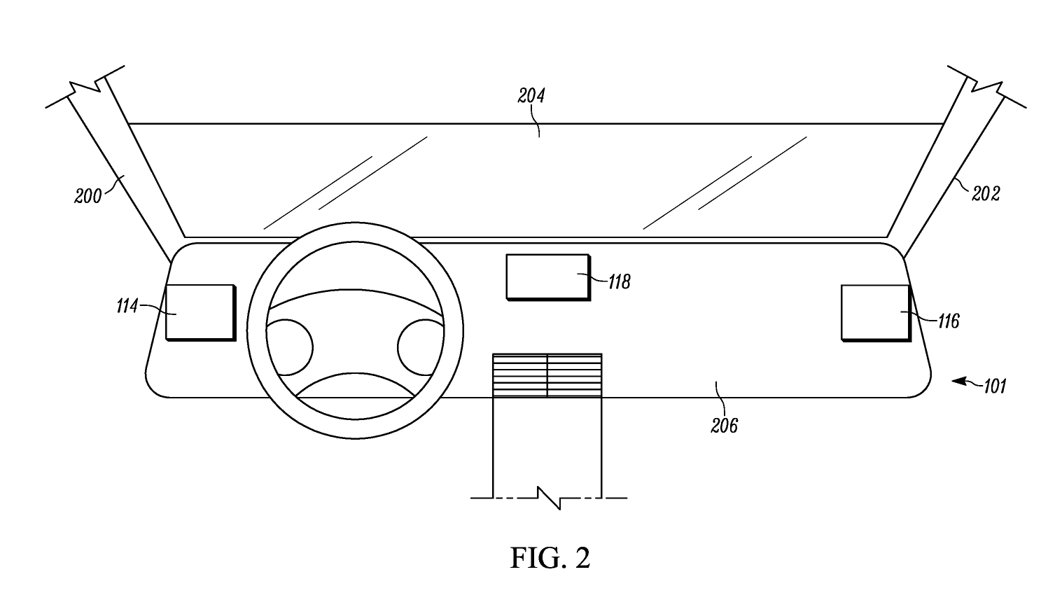

As shown in FIGS. 1 and 2, the displays 114, 116 are disposed near the edges 106, 110 of the vehicle 100. In the exemplary embodiment shown in FIG. 2, the first display 114 is disposed adjacent to or near a first A-pillar 200 while the second display 116 is disposed adjacent to or near a second A-pillar 202. Those of ordinary skill in the art appreciate that vehicle A-pillars 200, 202 are typically disposed near a front of a cabin of the vehicle 100, on either side of a windshield 204, to connect a roof (not shown) of the vehicle 100 to a body (not specifically numbered) of the vehicle 100.

The displays 114, 116 shown in FIG. 2 are disposed in a dashboard 206 of the vehicle 100. However, it should be appreciated that the first and second displays 114, 116 may be disposed in other locations. For example, the first and second displays 114, 116 may be coupled to and/or a part of the A-pillars 200, 202.

The first and second displays 114, 116 may be used in place of, or in addition to, standard side-view mirrors (not shown). The first and second displays 114, 116 have several advantages of standard side-view mirrors. One advantage is that the displays 114, 116 are less susceptible to frost or fogging than mirrors. Another advantage is that the displays 114, 116 are closer to the driver and, as such, require less eye and/or head movement to see the field-of-views 108, 112 provided by the cameras 102, 104. Also, by eliminating the standard side-view mirrors, the overall width of the vehicle 100 may be reduced, which can be advantageous in narrow roadways. Of course, other advantages may also be realized.

The vehicle 100 may also include a third display 118. The third display 118 may be configured to display images associated with a rear of the vehicle 100. The third display 118 may be disposed in a center region of the dashboard 206, as shown in FIG. 2, to supplement or replace a rear-view mirror (not shown).

The vehicle includes an interior compartment 120. In the exemplary embodiments, the displays 114, 116, 118 are disposed within the interior compartment. This protects the displays for water, ice, dirt, and other elements that could potential damage and/or obscure the displays 114, 116, 118.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A camera-display system for a vehicle having two sides, said system comprising:
a camera configured to capture images associated with a field-of-view adjacent one side of the vehicle; and
a display disposed adjacent the side of the vehicle and in communication with the camera to display the images captured by the camera.

2. The camera-display system as set forth in claim 1 wherein the display is disposed adjacent an A-pillar of the vehicle.

3. The camera-display system as set forth in claim 2 wherein the vehicle has an interior compartment and the display is disposed in the interior compartment.

4. The camera-display system as set forth in claim 1 wherein the vehicle has an interior compartment and the display is disposed in the interior compartment.

5. The camera-display system as set forth in claim 1 further comprising a processor in communication with the camera and the display and configured to receive signals from the camera, condition the signals, and provide the conditioned signals to the display.

6. A vehicle having two sides, comprising:
a camera configured to capture images associated with a field-of-view adjacent one side; and
a display disposed adjacent the side of the vehicle and in communication with the camera to display the images captured by the camera.

7. The vehicle as set forth in claim 6 further comprising two A-pillars and the display is disposed adjacent one of the A-pillars.

8. The vehicle as set forth in claim 7 further defining an interior compartment wherein the display is disposed in the interior compartment.

9. The vehicle as set forth in claim 6 further defining an interior compartment wherein the display is disposed in the interior compartment.

10. The vehicle as set forth in claim 6 further comprising a processor in communication with the camera and the display and configured to receive signals from the camera, condition the signals, and provide the conditioned signals to the display.

11. The vehicle as set forth in claim 6 wherein the side is substantially free of outward projections.
